(19) United States
(12) Patent Application Publication
(10) Pub. No.: US 2024/0375912 A1
(43) Pub. Date: Nov. 14, 2024

(54) GUIDERAIL FISHPLATE

(71) Applicant: Otis Elevator Company, Farmington, CT (US)

(72) Inventors: Javier Muñoz Sotoca, Rivas-Vaciamadrid (ES); Luis Mena Rosell, Getafe (ES)

(21) Appl. No.: 18/519,958

(22) Filed: Nov. 27, 2023

(30) Foreign Application Priority Data
May 11, 2023 (EP) 23382439.0

(51) Int. Cl. B66B 7/02; B31F 1/00

(52) U.S. Cl. CPC B66B 7/026; B31F 1/0009

(57) ABSTRACT

A fishplate (1, 1′) for joining two lengths of guide rail (2a, 2b, 2a′, 2b′) of an elevator system (100), the fishplate (1, 1′) formed from a sheet material, the fishplate (1, 1′) including a first layer (10a, 10a′); and a second layer (10b, 10b′) extending substantially parallel to the first layer (10a, 10a′), wherein the first layer (10a, 10a′) and the second layer (10b, 10b′) are connected along a fold line (12, 12′).

### FOREIGN PRIORITY

This application claims priority to European Patent Application No. 23382439.0, filed May 11, 2023, and all the benefits accruing therefrom under 35 U.S.C. § 119, the contents of which in its entirety are herein incorporated by reference.

### TECHNICAL FIELD

This disclosure relates to a fishplate for joining two lengths of guide rail of an elevator system, an elevator system comprising such a fishplate, and to a method of manufacturing such a fishplate.

### BACKGROUND

It is known to use a fishplate to attach together two vertically adjacent lengths of guide rail within an elevator hoistway (i.e., to mount two guide rails together lengthways). A fishplate contains a series of holes, through which fasteners (e.g., nuts and bolts) may be passed in order to fasten the fishplate to a piece of guide rail. By fastening the fishplate to both a first length of guide rail and a second length of guide rail, the lengths of guide rail are thereby fastened together.

It is known to form a fishplate from a thick steel plate, through which a series of holes are formed to enable fastening. The thick steel plate may, for example, be milled or machined to form the holes and optionally to give it any other desired shaping. The thick steel plate may be at least 10 mm thick. As a result, the manufacturing process can be difficult and costly, and the resulting piece may be heavy.

The present invention seeks to address these shortcomings.

### SUMMARY

According to a first aspect of the present disclosure, there is provided a fishplate for joining two lengths of guide rail of an elevator system, the fishplate formed from a sheet material, the fishplate comprising: a first layer; and a second layer extending substantially parallel to the first layer, wherein the first layer and the second layer are connected along a fold line.

According to a second aspect of the present disclosure, there is provided an elevator system, comprising; a hoistway; a first length of guide rail, extending along the hoistway; a second length of guide rail, extending along the hoistway; a fishplate as referred to above and described in greater detail below, wherein the fishplate is secured to a first end of the first length of guide rail and to a second end of the second length of guide rail so as to join the first end to the second end so that the first length of guide rail abuts against the second length of guide rail to form a continuous length of guide rail comprising both the first length of guide rail and the second length of guide rail.

It will be understood by the skilled person that a continuous length of guide rail does not require complete material continuation along the guide rail, as is clearly not the case where two lengths of guide rail are placed adjacent to each other and fastened together with a fishplate. Rather, the first and second lengths, when attached by the fishplate, form a continuous length of guide rail in the sense that an elevator car is able to achieve continuous travel along that length of guide rail, i.e., to travel smoothly along the first length and onto the second length, or vice versa, when travelling upwards or downwards along the extent of the hoistway.

As the first length of guide rail abuts against the second length of guide rail (i.e., end-to-end), it will be appreciated that the fishplate is not arranged interposed between the guide-rail-ends, but rather is arranged to overlap with each of the guide rail ends, and lie against their surface. The fishplate may contact a surface of the guide rails other than the surface along which the elevator car moves, e.g., a surface opposite to the surface along which the elevator car travels (i.e., behind the guide rails).

According to a third aspect of the present disclosure, there is provided a method of manufacturing a fishplate for a guide rail of an elevator system, the method comprising: folding a sheet material along a fold line to form a folded piece comprising at least a first layer and a second layer, extending substantially parallel to the first layer.

Thus, it will be understood that the fishplate is formed as a folded piece, i.e., comprising at least a first layer and a second layer, wherein the first layer and the second layer are formed by folding a sheet of material. By forming the fishplate from a sheet material which is folded to give two layers of material, adjacent to each other, a fishplate is provided which is able to be manufactured at lower cost than known thick steel plates, which requires less material and has a reduced weight by comparison, but which provides sufficient strength (possibly even higher strength) than known fishplates. Thus, the claimed fishplate may provide greater strength whilst using less material than known arrangements.

The second layer is arranged to extend substantially parallel to the first layer. By this it will be understood that the first layer and the second layer have the same profile shape, such that they are substantially the same distance apart (which may be no distance at all apart, i.e., in contact) throughout the width and length of the fishplate.

It will further be understood that by the first layer and the second layer being connected along a fold line it is meant that the material extending between the first layer and the second layer (i.e., joining them together) is continuous with both the first layer and the second layer. The first layer and the second layer are connected along a fold line as a result of being formed by folding the sheet material.

The fishplate may be formed from a single piece of sheet material. This provides a particularly simple construction since multiple separate pieces do not need to be joined together to form the fishplate, rather a single piece is shaped so as to be able to provide the fishplate.

In some examples the first layer and the second layer overlap throughout the extent (i.e., the length and width extent) of the fishplate such that the thickness (i.e., in the direction perpendicular to the length and the width) of the fishplate throughout the extent comprises at least the first layer and the second layer.

In some examples, the fold line is a centre line of the piece of sheet material. Thus, the first layer and the second layer may have substantially the same size, i.e., the same length and width. The first layer and the second layer have the same thickness, i.e., the thickness of the sheet material that is used to form the layers. Provided that the sheet material is not cut after folding, the sheet material may be folded along its centre line to form the first and second layers (but where the sheet material is trimmed after folding the fold line may not be the centre line at the time of folding, but may later become the centre line once the first and second layers are cut to be the same size). Thus, in some examples of the method, folding the sheet material along the fold line comprises folding the sheet material in half.

In some examples, the thickness of the sheet material is between 1 mm and 7 mm. In some examples, the thickness of the sheet material is between 2 mm and 4 mm. In some examples, the thickness of the sheet material is less than or equal to 5 mm. In some examples, the thickness of the sheet material is less than or equal to 3 mm. It will be understood that the “thickness” of the sheet material refers to the distance that the sheet material extends in a direction perpendicular to its sheet surface, i.e. to the plane defined by the planar sheet surface.

In some examples, the thickness of the fishplate is between 4 mm and 10 mm. In some examples, the thickness of the fishplate is between 5 mm and 8 mm. In some examples, the thickness of the fishplate is less than or equal to 8 mm. In some examples, the thickness of the fishplate is less than or equal to 6 mm. It will be understood that the “thickness” of the fishplate refers to the distance that the fishplate material extends in a direction perpendicular to the first and second layers. The thickness of the fishplate may be substantially equal to twice the thickness of the sheet material, i.e. there is little to no gap between the first layer and the second layer.

In some examples the sheet material comprises a single type of material. In some examples the sheet material comprises a plurality of types of material. In some examples the sheet material is metal (or alloy). In some examples the sheet material is steel, e.g., galvanized steel. In standard elevator systems certain components (e.g. elevator guide rails and fishplates) are made from steel components as they provide the best material properties with a smooth guiding surface and high strength and toughness. It is desirable to use a sheet material which exhibits similar properties, of strength and toughness, whilst enabling the sheet material to be bent into the required predetermined shape(s).

In some examples, the fishplate further comprises at least two holes, wherein each hole extends through both the first layer and the second layer. These holes allow for fastening the fishplate to both a first length of guide rail and a second length of guide rail, so as to join the guide rails together to form one continuous length of guide rail. Thus, in some examples, the method comprises forming at least two holes through the folded piece, wherein each hole extends through both the first layer and the second layer.

In some examples, the fishplate comprises at least four holes, optionally at least six holes, further optionally eight holes. Thus, in some examples, the method comprises forming at least four holes through the folded piece, optionally at least six holes, further optionally eight holes. The holes may be formed by drilling through the folded piece, i.e. through the first layer and the second layer.

In some examples, the fishplate has a rectangular shape. Thus, in some examples, each of the first layer and the second layer have a rectangular shape. The fishplate may have a rectangular shape when viewed along a first direction (i.e., a direction defined by a first axis). By this it will be understood that when viewed along a direction substantially perpendicular to the surface of the layers, the fishplate has a rectangular outline, with two parallel short edges, and two long edges perpendicular to the two short edges.

In some examples, the at least two holes are arranged symmetrically relative to a central long axis of the rectangular shape (i.e., the long line of symmetry of the rectangle). In some examples, the at least two holes are arranged symmetrically relative to a central short axis of the rectangular shape (i.e., the short line of symmetry of the rectangle). Thus, in some examples, the at least two holes are arranged symmetrically relative to both axes of symmetry of the rectangle. This symmetrical arrangement of holes within the fishplate enables secure fastening of the fishplate to lengths of guide rail, in a manner that evenly distributes the forces acting on the fishplate. The two or more holes may be aligned along the first direction, i.e., parallel to the first axis.

In some examples, the fold line is along one of the long sides of the rectangle (i.e., such that, in position joining two guide rail lengths, the fold line extends along the length of the guide rails).

In some examples, the fishplate further comprises a flange formed along (i.e., extending along) an edge of the fishplate. Thus, in some examples, the method further comprises deforming the folded piece to form a flange along an edge of the fishplate. The flange may be formed along a long edge of the fishplate (e.g. a long edge of a rectangular fishplate, as described above). The flange may extend along a second direction (i.e., defined by a second axis), perpendicular to the first direction. The flange may project away from the rest of the fishplate (e.g., away from a central portion) along a first direction, perpendicular to the second direction.

The fishplate may comprise a second flange. Thus, in some examples, the method further comprises deforming the folded piece to form a second flange. The second flange may be formed along an edge of the fishplate, opposite to the edge along which the first flange is formed. The second flange may be formed along the second long edge of the fishplate (i.e., the edge on the opposite side from the edge along which the first flange is formed). The second flange may extend along the second direction. The second flange may project away from the rest of the fishplate (e.g., away from a central portion) along the first direction. The method may comprise forming the first flange and the second flange in a single step (e.g., simultaneously).

Deforming the folded piece to form a flange along an edge of the fishplate may comprise folding the folded piece (i.e., creating one or more further folds) or stamping the folded piece.

It will be understood by the skilled person that the (or each) flange is a rib, lip or rim formed along an edge of the fishplate (optionally extending along the entire length of the edge) by deforming (e.g. bending, pressing or stamping) the material at that edge of the fishplate. The (or each) flange may be bent at an angle relative to the fishplate (i.e., relative to the rest of the fishplate, for example, relative to a central portion of the fishplate, which may be a substantially planar surface of the fishplate). For example, the flange may be bent at (i.e., project from the fishplate at) an angle of between 45° and 120°, optionally between 70° and 100°, further optionally at an angle of approximately 90°. Thus, in some examples, the flange may project substantially perpendicularly to the fishplate (i.e., to the rest of the fishplate, optionally to a central, substantially planar portion of the fishplate). The one or more flanges may be formed to project, in use, towards or around the lengths of guide rail.

In some examples, the method comprises forming the holes (i.e., the at least two holes, optionally at least four holes, further optionally at least six holes, further optionally eight holes) before forming the one or more flanges. Alternatively, the method further comprises forming the holes (i.e., the at least two holes, optionally at least four holes, further optionally at least six holes, further optionally eight holes) after forming the one or more flanges. Further alternatively, some holes may be formed before forming the flange, and other holes may be formed after forming the flange.

In some examples, the fishplate further comprises a protrusion (e.g., a ridge), formed along a central portion of the fishplate (e.g., extending along the elongate direction of a rectangular fishplate, i.e., substantially parallel to a long edge). The protrusion may extend along the second direction. It may extend along the same direction that the one or more flanges extend. The protrusion may protrude out of an otherwise planar surface of the fishplate, i.e., relative to an imaginary flat plane defined by the central portion of the fishplate (e.g., between two flanges). The protrusion may protrude along the first direction. The protrusion may protrude in a direction that is opposite to the direction in which the one or more flanges project, i.e., the protrusion may protrude away from the fishplate along the first direction (i.e., parallel to the first axis), and the flanges may project away from the fishplate also parallel to the same axis, the first axis, but the other way, i.e., in an opposite direction. The protrusion may be formed to protrude, in use, away from the lengths of guide rail. Thus, in some examples, the method further comprises deforming the folded piece to form a protrusion along a central portion of the fishplate.

The protrusion may extend at least 25% of the distance along the width of the central portion or along the width of the rectangular shape of the fishplate, i.e., when viewed along the first axis, optionally at least 30%, optionally at least 50%.

The protrusion may be step-shaped (i.e., have a step-shaped profile, e.g., viewed along an elongate axis of the fishplate, e.g., along the second axis). Thus, the protrusion may comprise a substantially planar top surface, e.g., in addition to two sloped side portions.

Deforming the folded piece to form a protrusion along a central portion of the fishplate may comprise stamping the folded piece.

The protrusion and the one or more flanges may be formed in a single stamping process or stage. For example, the fishplate may be stamped onto a single die, shaped to have a flange on either edge of the fishplate, projecting along a first direction, and to form a protrusion (e.g., along a centre line of the fishplate) protruding outwards parallel to the first axis, but in a second direction, opposite to the first direction.

In some examples, the method comprises forming the holes (i.e., the at least two holes, optionally at least four holes, further optionally at least six holes, further optionally eight holes) before forming the protrusion (and optionally also the flange(s) when they are formed in the same process). Alternatively, the method further comprises forming the holes (i.e., the at least two holes, optionally at least four holes, further optionally at least six holes, further optionally eight holes) after forming the protrusion (and optionally also the flange(s) when they are formed in the same process). Further alternatively, some holes may be formed before forming the protrusion, and other holes may be formed after forming the protrusion.

Thus, as set out above, in some examples, a method of manufacturing a fishplate for a guide rail of an elevator system is provided, which comprises: folding a sheet material along a fold line to form a folded piece comprising at least a first layer and a second layer, extending substantially parallel to the first layer; stamping the folded piece to form a first flange along a first edge of the fishplate, a second flange along a second edge of the fishplate, and a protrusion along a central portion of the fishplate; and forming at least two holes through the folded piece, wherein each hole extends through both the first layer and the second layer.

Further, as set out above, in other examples, a method of manufacturing a fishplate for a guide rail of an elevator system is provided, which comprises: folding a sheet material along a fold line to form a folded piece comprising at least a first layer and a second layer, extending substantially parallel to the first layer; folding the folded piece further to form a first flange along a first edge of the fishplate and a second flange along a second edge of the fishplate; and forming at least two holes through the folded piece, wherein each hole extends through both the first layer and the second layer.

### DRAWING DESCRIPTION

Certain preferred examples of this disclosure will now be described, by way of example only, with reference to the accompanying drawings, in which:

FIG. 1 is a front view of a fishplate according to a first example of the present disclosure, viewed along a first axis;

FIG. 2 is a perspective view of the fishplate of FIG. 1, joining two adjacent lengths of guide rail;

FIG. 3 is a perspective view of the fishplate of FIG. 2, showing the opposite side of the fishplate and the guide rails;

FIG. 4 is a cross-sectional view of the fishplate of FIG. 1 during its construction, taken along line 60 and viewed along a second axis, perpendicular to the first axis;

FIG. 5 is a cross-sectional view of the fishplate of FIG. 1 during its construction, taken along line 60 and viewed along a second axis, perpendicular to the first axis;

FIG. 6 is a cross-sectional view of the fishplate of FIG. 1, in position joining two lengths of guide rail;

FIG. 7 is a perspective view of the fishplate of FIG. 1, viewed from an opposite side to the view of FIG. 1;

FIG. 8 is a cross-sectional view of a fishplate according to a second example of the present disclosure, during its construction;

FIG. 9 is a cross-sectional view of a fishplate according to a second example of the present disclosure, during its construction;

FIG. 10 is a cross-sectional view of a fishplate according to a second example of the present disclosure; and

FIG. 11 is a schematic drawing showing an elevator system according to an example of the present disclosure.

### DETAILED DESCRIPTION

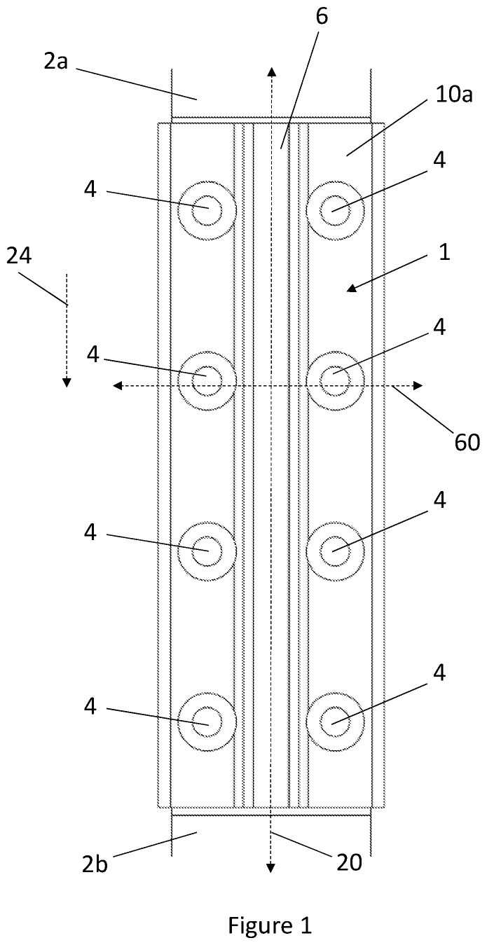

FIG. 1 is a front view of a fishplate 1 according to a first example of the present disclosure. The fishplate 1 has a rectangular shape, viewed from the perspective of FIG. 1, along the first axis 22 which is seen in FIG. 6 and described further below. It is fixed to a first guide rail length 2a and a second guide rail length 2b, so as to attach the two lengths together to form a continuous guide rail with a surface (not shown) along which an elevator car is able to travel continuously. From this view a first layer 10a of the fishplate 1 is visible.

The fishplate 1 includes eight holes 4, which enable it to be fastened to each of the first and second lengths 2a, 2b, so as to fasten the two lengths together.

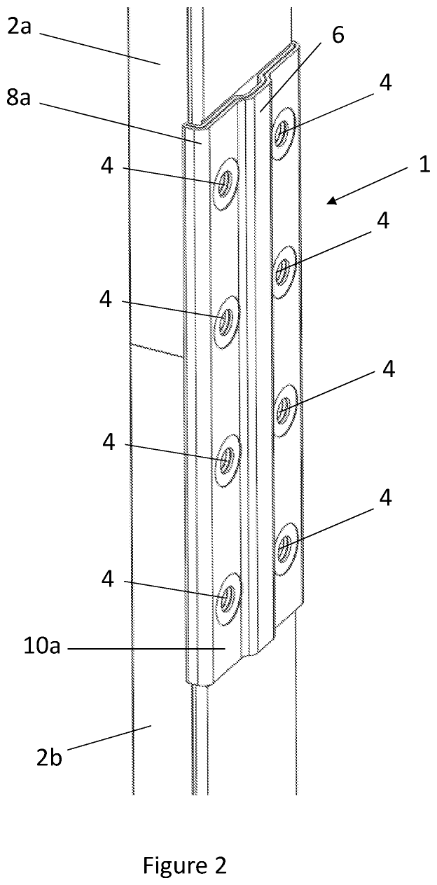

The fishplate 1 is shown from a perspective further to the side in FIG. 2. From this view a flange 8a formed to extend along one edge of the fishplate 1 is visible. It can be seen that the flange 8a is engaged with an outer side of the lengths of guide rail 2a, 2b, so as to provide a stabilizing force to the fishplate 1 and help to prevent any rotation or displacement of the fishplate 1 once it is fixed in position attached to both of the lengths of guide rail 2a, 2b. The flanges 8a, 8b, and also the protrusion 6 discussed below, increase the moment of inertia of the fishplate 1 at least along an axis of rotation 26, seen in FIG. 6, which is perpendicular to both the first axis 22 and the second, elongate axis 20 (i.e., along an axis that runs across the width of the fishplate and the guide rail), which helps the fishplate to prevent rotation of one guide rail length about this axis relative to the other guide rail length, during use.

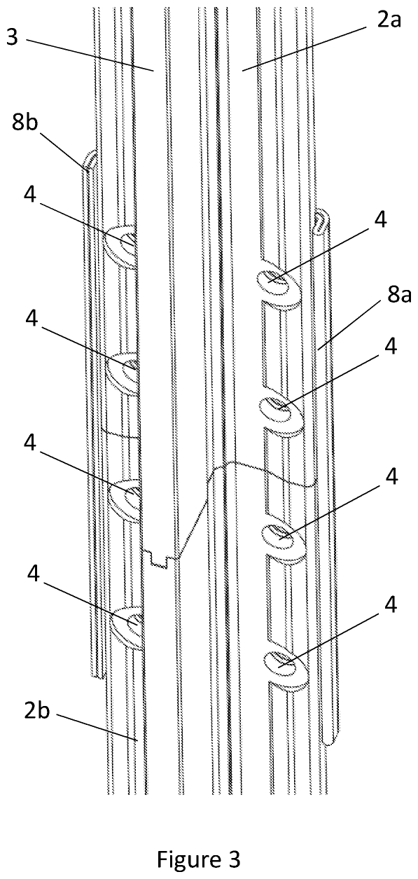

FIG. 3 is a perspective view showing the opposite side of the arrangement of FIG. 2, i.e., the view from the other side of the guide rails. From this angle both flanges 8a, 8b are visible. The engagement surface 3 of the guide rail lengths 2a, 2b along which the elevator car travels is also visible in this view.

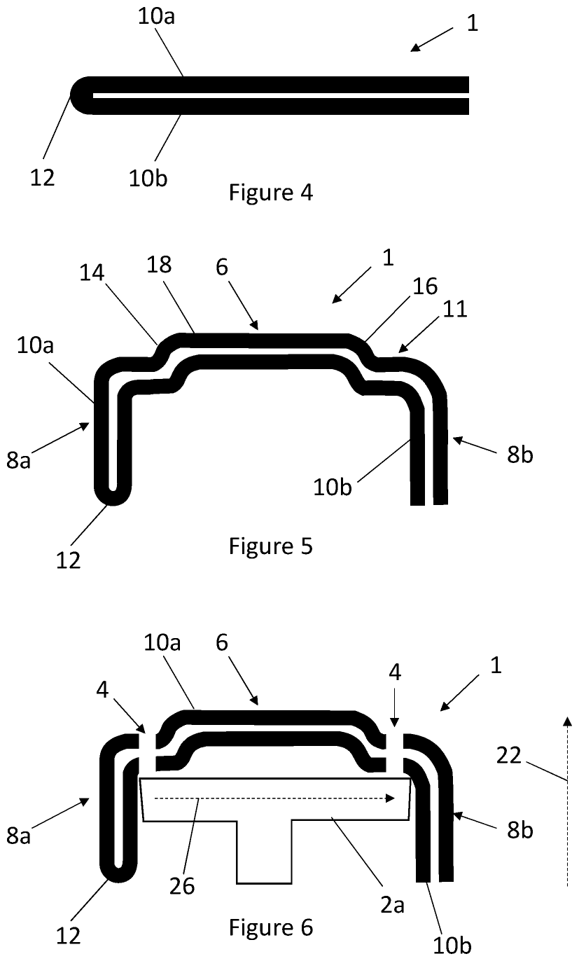

FIG. 6 shows a first axis 22 along which the view of FIG. 1 is seen (when the guide rail is not present). FIG. 6 shows a cross-sectional view of the fishplate 1, along the line 60 of FIG. 1, viewed along the direction of a second axis 24, seen in FIG. 1. Viewed along this first axis 22 the fishplate 1 has a rectangular shape, as seen in FIG. 1. FIGS. 4 and 5 are cross-sectional views of the fishplate through the same line, during its construction.

The process of manufacturing the fishplate 1 begins with a substantially planar piece of sheet material. In a first stage, the sheet material is folded along a fold line 12, e.g., folded in half. As a result, a structure is formed which comprises a first layer 10a and a second layer 10b, which extends substantially parallel to the first layer. Although a gap is shown between the layers 10a, 10b, in fact no gap, or only a very small gap, may be present. As is seen in FIG. 4, the structure has a closed edge along one side, and an open edge, comprising the outer edges of each of the first layer 10a and the second layer 10b on the other side.

In this example, the folded piece of sheet material shown in FIG. 4 is next stamped to give a shape to the fishplate 1.

In particular, the folded sheet material is stamped (e.g., onto a die) to form a shape having a central portion 11, where the central portion 11 includes a protrusion 6, and also having flanges 8a, 8b formed along the opposing long edges of the fishplate 1. The protrusion 6 protrudes away from the rest of the (otherwise substantially planar) surface of the central portion 11, in a first direction parallel to the first axis 22. It is substantially step shaped, having a first side portion 14, a second side portion 16 and a substantially planar top surface 18. The flanges 8a, 8b also project along a direction defined by the first axis 22, but in a second direction, opposite to the direction in which the protrusion protrudes.

Holes 4 are then drilled in the substantially planar part of the central portion 11, on either side of the protrusion 6. Although only two holes 4 are visible in this cross-sectional view, there are a total of eight holes, as seen in FIGS. 1-3.

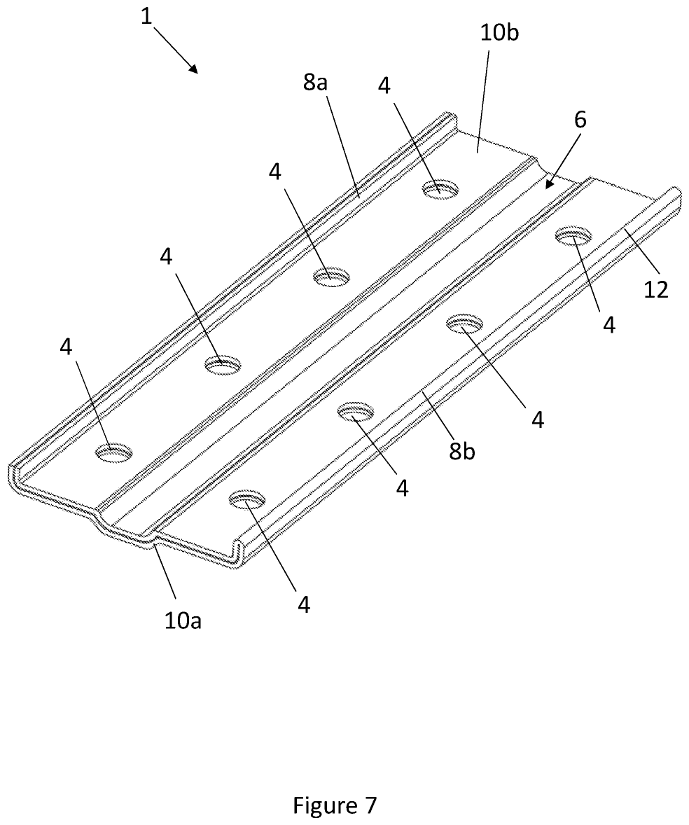

FIG. 7 is a perspective view of the fishplate of FIG. 1, viewed from an opposite side, such that the second layer 10b is visible. The step shape of the protrusion 6, extending along the elongate central axis of the fishplate 1 and protruding out of the fishplate along the first direction, defined by the first axis 22, is visible from this view, as are the flanges 8a, 8b which from this view project upwards. In use the second layer 10b contacts the guide rails (i.e., the “back” surface of the guide rails, opposite to the surface along which the elevator car travels).

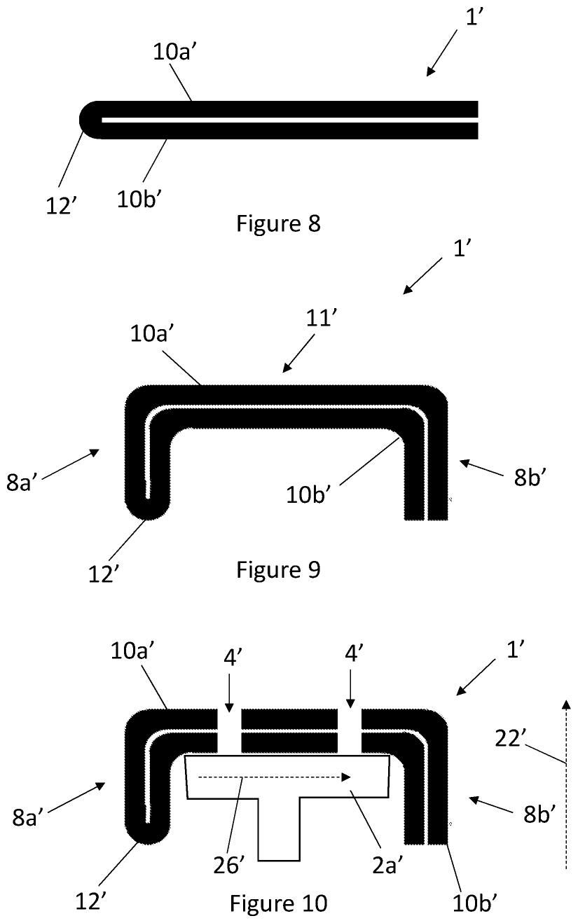

FIG. 8 is a cross-sectional view of a fishplate 1′ according to a second example of the present disclosure, during its construction. This fishplate 1′ has many similar features to the fishplate 1 of the first example, and these like features have been labelled with the same reference numeral but followed by an apostrophe, and will not be described in detail again.

The process of manufacturing the fishplate 1′ begins with a substantially planar piece of sheet material. In a first stage, the sheet material is folded along a fold line 12′, e.g., folded in half. As a result, a structure is formed which comprises a first layer 10a′ and a second layer 10b′, which extends substantially parallel to the first layer. Although a gap is shown between the layers 10a′, 10b′, in fact no gap, or only a very small gap, may be present. As is seen in FIG. 8, the structure has a closed edge along one side (the fold line 12′), and an open edge, comprising the outer edges of each of the first layer 10a′ and the second layer 10b′ on the other side.

The fishplate 1′ of this second example is then folded to produce flanges 8a′ and 8b′, along respective long edges of the fishplate 1′. As seen, the flanges 8a′, 8b′ are formed along opposite edges of the fishplate 1′ and extend away from the central portion 11′ of the fishplate approximately at a right angle, i.e., at 90°. These flanges 8a′, 8b′, like those described above, have the effect of increasing the moment of inertia of the fishplate 1′ along the illustrated rotation axis 26′.

Holes 4′ are then drilled in the substantially planar central portion 11′. Although only two holes 4′ are visible in this cross-sectional view, a total of eight holes may be drilled, similar to the holes seen in the first example.

FIG. 10 shows the fishplate 1′ arranged in contact with a length of guide rail 2a′. As seen, the flanges 8a′, 8b′ project towards and around the guide rail 2a′, along the first direction, defined by the first axis 22′.

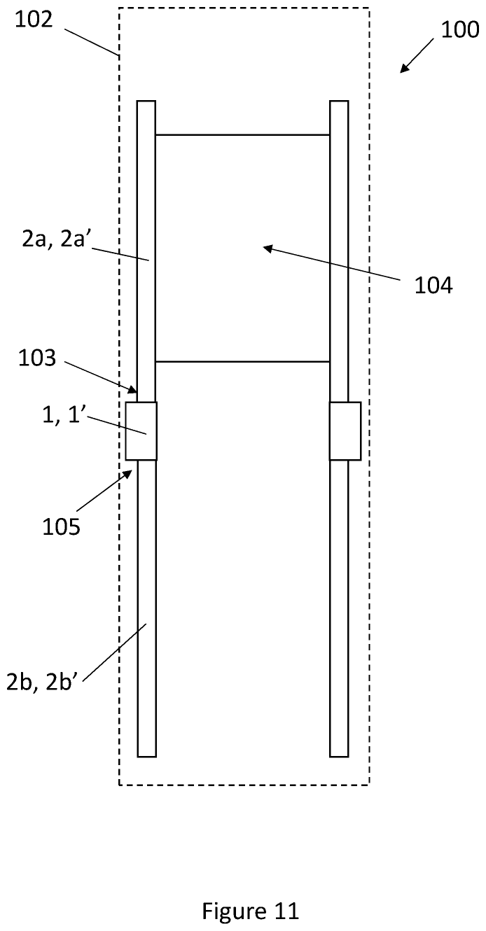

FIG. 11 is a schematic drawing showing an elevator system 100 according to an example of the present disclosure. It will be appreciated that not all components of the elevator system 100 are illustrated, rather only those which are relevant to the present disclosure are described.

The elevator system is arranged within a hoistway 102. A first length of guide rail 2a, 2a′, and a second length of guide rail 2b, 2b′ are arranged to extend along the hoistway 102 on a first side of the hoistway 102 (the left-hand side in the view of FIG. 11). There are also corresponding guide rail lengths arranged on the opposite side of the hoistway 102.

A fishplate 1, 1′, which is a fishplate according to either of the examples described above, is secured to a first end 103 of the first length of guide rail 2a, 2a′ and to a second end 105 of the second length of guide rail 2b, 2b′. The fishplate 1, 1′ joins the first end 103 to the second end 105 so that the first length of guide rail 2a, 2a′ abuts against the second length of guide rail 2b, 2b′ to form a continuous length of guide rail comprising both the first length of guide rail 2a, 2a′ and the second length of guide rail 2b, 2b′.

It will be appreciated by those skilled in the art that the disclosure has been illustrated by describing one or more specific aspects thereof, but is not limited to these aspects; many variations and modifications are possible, within the scope of the accompanying claims.

1. A fishplate (1, 1′) for joining two lengths of guide rail (2a, 2b, 2a′, 2b′) of an elevator system (100), the fishplate (1, 1′) formed from a sheet material, the fishplate (1, 1′) comprising:
a first layer (10a, 10a′) having a first surface and a second surface; and
a second layer (10b, 10b′) having a third surface and a fourth surface, the third surface and the fourth surface extending substantially parallel to the first layer (10a, 10a′) first surface and the second surface,
wherein the first layer (10a, 10a′) and the second layer (10b, 10b′) are connected along a fold line (12, 12′).

2. The fishplate (1, 1′) of claim 1, further comprising a flange (8a, 8b, 8a′, 8b′) formed along an edge of the fishplate (1, 1′).

3. The fishplate (1, 1′) of claim 1, further comprising a protrusion (6), formed along a central portion (11, 11′) of the fishplate (1, 1′).

4. The fishplate (1, 1′) of claim 1, wherein the thickness of the sheet material is less than 5 mm.

5. The fishplate (1, 1′) of claim 1, wherein the thickness of the fishplate (1, 1′) is less than 8 mm.

6. The fishplate (1, 1′) of claim 1, wherein the fold line (12, 12′) is a centre line of the piece of sheet material.

7. The fishplate (1, 1′) of claim 1, wherein the sheet material is steel.

8. The fishplate (1, 1′) of claim 1, further comprising at least two holes (4), wherein each hole (4) extends through both the first layer (10a, 10a′) and the second layer (10b, 10b′).

9. An elevator system (100), comprising;
a hoistway (102);
a first length of guide rail (2a, 2a′), extending along the hoistway (102);
a second length of guide rail (2b, 2b′), extending along the hoistway (102);
a fishplate (1, 1′) as claimed in claim 1, wherein the fishplate (1, 1′) is secured to a first end (103) of the first length of guide rail (2a, 2a′) and to a second end (105) of the second length of guide rail (2b, 2b′) so as to join the first end (103) to the second end (105) so that the first length of guide rail (2a, 2a′) abuts against the second length of guide rail (2b, 2b′) to form a continuous length of guide rail comprising both the first length of guide rail (2a, 2a′) and the second length of guide rail (2b, 2b′).

10. A method of manufacturing a fishplate (1, 1′) for a guide rail (2a, 2b, 2a′, 2b′) of an elevator system (100), the method comprising:
folding a sheet material along a fold line (12, 12′) to form a folded piece comprising at least a first layer (10a, 10a′) having a first surface and a second surface and a second layer (10b, 10b′) having a third surface and a fourth surface, the third surface and the fourth surface, extending substantially parallel to the first surface and the second surface.

11. The method of claim 10, further comprising deforming the folded piece to form a flange (8a, 8b, 8a′, 8b′) along an edge of the fishplate (1, 1′).

12. The method of claim 11 wherein deforming the folded piece to form a flange (8a, 8b, 8a′, 8b′) along an edge of the fishplate (1, 1′) comprises folding or stamping the folded piece.

13. The method of claim 10, further comprising deforming the folded piece to form a protrusion (6) along a central portion (11) of the fishplate (1).

14. The method of claim 10, further comprising forming at least two holes (4) through the folded piece, wherein each hole (4) extends through both the first layer (10a, 10a′) and the second layer (10b, 10b′).

15. The method of claim 10, wherein the fold line (12, 12′) is a centre line of the sheet material.

16. The fishplate of claim 1, wherein each guiderail of the two lengths of guide rail includes a first axis, a second axis and a third axis, the first axis, the second axis and the third axis being perpendicular to each other;
each guiderail including an engagement surface along which the elevator car travels, the engagement surface having a longitudinal axis parallel to the second axis, the engagement surface having a width along the third axis and the engagement surface having a height along the first axis,
the first surface, the second surface, the third surface and the fourth surface being parallel to a plane defined by the second axis and third axis.
